(19) United States
(12) Patent Application Publication
(10) Pub. No.: US 2002/0147820 A1
(43) Pub. Date: Oct. 10, 2002

(54) Method for implementing IP security in mobile IP networks

(75) Inventor: Aki Yokote, San Francisco, CA (US)

Correspondence Address: BRINKS HOFER GILSON & LIONE, P.O. BOX 10395, CHICAGO, IL, 60610, US

(73) Assignee: DoCoMo Communications Laboratories USA, Inc.

(21) Appl. No.: 09/827,632

(22) Filed: Apr. 6, 2001

(51) Int. Cl. G06F 15/16

(52) U.S. Cl. 709/229; 709/230

(57) ABSTRACT

A method for implementing IPsec in third generation and beyond wireless, mobile access, Internet protocol-based digital networks supporting Mobile IP is disclosed. A sending node initiates establishment of a security association for a receiving node, rather than waiting for the receiving node to initiate security association establishment after receiving a packet from the sending node. Thus, the disclosed method greatly reduces packet delay introduced by required authentication and security association establishment processes. The IPsec may use the Kerberos key exchange method. The Kerberos key exchange method, since it requires less computational overhead, is a suitable IPsec method for mobile IP networks where less resourceful devices such as PDAs and cellular phones are primary network access devices. Since the Kerberos key exchange method requires less computational overhead, packet delay associated with authentication and security processes are further reduced.

### BACKGROUND OF THE INVENTION

1. Field of the Invention

The invention relates generally to Internet Protocol Security (IPsec) implemented in a wireless, mobile Internet protocol-based networks and more particularly to IPsec offered for real-time interactive digital data communications such as voice over IP (VoIP) in third generation and beyond wireless, mobile-access, Internet protocol-based data networks and wireless LANs.

2. Statement of Related Art

Digital data networks have become a ubiquitous part of business, commerce, and personal life throughout the United States and the world. The public Internet and private local and wide area networks (LANs and WANs) have become increasingly important backbones of data communication and transmission. E-mail, file access and sharing, and services access and sharing are but a few of the many data communication services and applications provided by such networks.

Nearly all digital data networks including the Internet today adhere to substantially the same addressing and routing protocols. According to these protocols, each of the network access devices (nodes) and servers (routers) in the network has a unique address, called the IP address. To communicate digital data over the network or between networks, a sender or source node subdivides the data to be transmitted into “packets.” A packet includes communication control data, such as the IP addresses of the source node and the intended destination node, and other information specified by the protocol, and substantive data to be passed on to the destination node. A single communication of data may require multiple packets to be created and transmitted depending on the amount of data being communicated and other factors. The source node transmits each packet separately, and the packets are routed via intermediary routers in the network from the source node to the destination node. The packets do not necessarily travel to the destination node via the same route, nor do they necessarily arrive at the same time. This is accounted for by providing each packet with a sequence indicator as part of the packetizing process. The sequence indicators permit the destination node to reconstruct the packets in their original order even if they arrive in a different order and at different times, thus allowing the original data to be reconstructed from the packets.

The International Telecommunication Union (ITU) of the Internet Society, the recognized authority for worldwide data network standards, has recently published its International Mobile Telecommunications-2000 (IMT-2000) standards. These standards propose so-called third generation (3G) and beyond (i.e., 3.5G, 4G etc.) data networks that include extensive mobile access by wireless, mobile nodes including cellular phones, personal digital assistants (PDAs), handheld computers, and the like. (See http://www.itu.int). The proposed third generation and beyond networks support IP based data communication, i.e., all data is communicated in digital form in packets via Internet addressing and routing protocols from end to end. Also, in the proposed third generation and beyond wireless networks, mobile nodes are free to move within the network while remaining connected to the network and engaging in data communications with other stationary or mobile network nodes. Among other things, such networks must therefore provide facilities for addressing of moving mobile nodes, dynamic rerouting of data packets between the communicating nodes, as well as handling security and authentication issues when mobile nodes change network connections and packet routes.

It is particularly important for networks to provide adequate mobility support to mobile nodes because mobile nodes are expected to account for a majority or at least a substantial fraction of the population of the Internet in the near future. The Internet Engineering Task Force (IETF), an international community of network designers, operators, vendors, and researchers concerned with the evolution of the Internet architecture and the smooth operation of the Internet, have proposed several standards for mobility support. (See http://www.ietf.org). These include proposed standards for IP Mobility Support such as IETF RFC 2002, also referred to as Mobile IP Version 4 (IPv4), and draft working document “draft-ietf-mobileip-ipv6-13”, entitled “Mobility Support in IPv6,” also referred to as Mobile IP Version 6, both of which are incorporated herein by reference. According to the protocol operations defined in Mobile IPv4 and IPv6, a mobile node is allowed to move from one link to another without changing the mobile node's IP address. A mobile node is always addressable by its “home address,” an IP address assigned to the mobile node within its home subnet prefix on its home link. Packets are routed to the mobile node using this address regardless of the mobile node's current point of attachment to the Internet, and the mobile node may continue to communicate with a correspondent node (stationary or mobile) after moving to a new link. The movement of a mobile node away from its home link is thus transparent to transport and higher-layer protocols and applications.

Mobile IPv6 shares many features with Mobile IPv4, but the protocol is fully integrated into IP and provides many improvements over Mobile IPv4. For instance, support for “Route Optimization” is built in as a fundamental part of the protocol in Mobile IPv6, rather than being added on as an optional set of extensions that may not be supported by all nodes as in Mobile IPv4. The Route Optimization functionality optimizes the routing of packets by establishing a direct route between mobile and correspondent nodes. As discussed above, each mobile node is always identified by its home address, regardless of its current point of attachment to the Internet. While situated away from its home, a mobile node is also associated with a care-of address, which provides information about its current point of attachment to the Internet. In Mobile IPv4, a mobile node operating away from home registers its care-of address with its home agent.

Likewise, in Mobile IPv6, a mobile node away from home sends a registration request to its home agent in order to notify the home agent of its current care-of address. The home agent that has received a registration request then intercepts packets destined for the mobile node and tunnels the packets to the mobile node's care-of address. In the reverse direction, however, packets are sent from the mobile node directly to its correspondent node. Thus, so-called triangle routing of packets occurs, which gives rise to the well-known asymmetrical packet latency problems. To establish a direct forwarding route from the corresponding node to the mobile node, the corresponding node is notified of the mobile node's current care-of address. In Mobile IPv4, the direct forwarding route may be established through the home agent sending binding information to an IPv4 mobile node when receiving from the corresponding node a packet destined to the mobile node away from home. In Mobile IPv6, establishment of direct routing is initiated by the mobile mode sending a binding update directly to the corresponding node.

Mobile IP also presents security issues. For instance, the registration protocol prescribed in Mobile IPv4 results in a mobile node's traffic being tunneled to its care-of address. This tunneling feature could however be a significant vulnerability if the registration was not authenticated between the home agent and the mobile agent. Also, the binding update operations standardized in Mobile IPv6 result in packets routed directly to a mobile node. This ability to change the routing of packets could raise a security concern if any packet containing a binding update was not authenticated between the mobile and correspondent nodes. These and other security issues associated with implementing mobile IP have long been recognized. In fact, relating RFC proposals discuss such security issues, but these proposals do nothing more than pointing out necessity of implementing IP security (IPsec) in the mobile environments and are silent about detailed implementations of IPsec in the mobile environments; yet, the Mobile IP working group in IETF has been discussing and studying the design of IPsec adaptable to the mobile environments.

On the other hand, the fundamentals of IPsec architecture are prescribed in IETF RFC 2401, entitled “Security Architecture for the Internet Protocol,” which is incorporated herein by reference. RFC 2401 proposes cryptographically-based IPsec consisting of a set of security services offered to address the issues of, for instance, connection integrity, data origin authentication, and confidentiality. Basically, the IPsec proposed in RFC 2401 relies upon a shared cryptographic key, with which communications between sender and receiver are encrypted and decrypted. Thus, for the IPsec proposed in RFC 2401 to work, sender and receiver must, before any communication to be protected takes place, establish agreements between them regarding a cryptographic key, an authentication or encryption algorithm, and a set of parameters needed to implement the algorithm. This set of agreements is called a security association (SA). Common methods for establishing a cryptographic key are key transport and key generation. An example of key transport is the use of a shared encryption key supplied from a trusted-third party authentication service. One of the most commonly used key generation methods is the Diffie-Hellman (D-H) algorithm. In the D-H algorithm, each of the sender and receiver mathematically combines the other's public information along with their own secret information to compute a shared encryption value. For details of the key management protocols, please see RFC 2408, entitled “Internet Security Association and Key Management Protocol,” which is incorporated therein by reference.

The above-described IPsec is applicable in both Mobile IPv4 and Mobile IPv6 environments. For instance, during a registration process in Mobile IPv4 in which a mobile node situated away from home is registering its care-of address with its home agent, the home agent and the mobile node negotiate for a mutually agreeable SA and establish an encryption key that is to be used to protect subsequent communications being tunneled between them. Similarly, the above IPsec is implemented in the Route Optimization operations according to Mobile IPv6. A mobile node situated away from home sends a binding update to a correspondent node to notify the mobile node's current point of attachment to the Internet. The mobile and correspondent nodes then negotiate for a mutually agreeable SA and determine a cryptographic key that is to be used to protect subsequent communications routed directly between them.

The above-proposed IPsec architecture works relatively well in mobile IP environments, yet efforts have been made to improve and better implement the proposed IPsec. For instance, the implementation of the proposed IPsec in mobile IP environments introduces certain time considerations into the process of establishing a SA between the mobile and correspondent nodes when Route Optimization is performed. For the very purpose of IPsec, Communication to be protected should not be allowed to take place before a SA is established. Therefore, a time used for establishing a SA manifests itself as a delay in communication. Communication delay may not cause serious problem for e-mail transmissions and file transfers because such data communications are not real-time interactive applications and therefore are not particularly sensitive to communication delay. However, the recent emergence of real-time interactive data communication applications, such as VoIP and real-time interactive multi-media, have presented substantial challenges for the implementation of the IPsec in mobile IP environments. Unlike e-mail and file transfers, such real-time interactive data communication applications are highly sensitive to timing considerations. Especially, VoIP is highly sensitive to intra-network processing, transmission and routing delays. Communication delay due to establishment of a SA becomes more significant if the key establishment process employs the key generation method, such as the D-H algorithm, which requires heavy computational overhead.

### SUMMARY OF THE INVENTION

Therefore, the purpose of the present invention is to provide a method that can reduce packet latency introduced by required authentication and security association establishment processes. Specifically, the present invention provides a method that allows a sending node to initiate the user authentication and the establishment of a security association, rather than waiting for a receiving node to initiate such processes after receiving a packet from the sending node. According to the method, the sending node initiates communication to the receiving node and checks if any security association is established with the receiving node. If no security association is established for communication with the receiving node, the sending node then initiates establishment of a security association. The receiving node may be situated away from its home link and send a binding update after receiving a packet from the sending node. In the present invention, establishment of a security association is initiated before the sending node receives a binding update from the receiving node. Thus, the present invention reduces packet latency introduced by authentication and security association establishment processes.

In one embodiment according to the present invention, the Kerberos key exchange method is used for the authentication and confidentiality purposes. The Kerberos key exchange method requires less computational overhead and thus suitable for mobile IP network where less resourceful devices such as PDAs and cellular phones are the primary network access devices. Since it requires less computational overhead, less time is required for authentication and security association establishment. Therefore, packet latency associated with authentication and security association establishment is further reduced.

In another embodiment, a Layer 2 secret key established for authentication of a mobile node to a radio network controller (RNC), is used also as a Layer 3 pre-shared secret key to authenticate the mobile node to a network. This will simplify key management operations in a mobile node.

Further in another embodiment, a network is provided with SA managers for managing SAs for nodes connected to the network. The SA managers will reduce memory overhead and computational overhead of less resourceful nodes, such as PDAs and cellular phones. The memory overhead of a cellar phone may be reduced by keeping SAs in a subscriber identification module.

### BRIEF DESCRIPTION OF THE DRAWINGS

FIG. 1 is a graphical representation of a third generation wireless, mobile access, IP network in which the present invention is intended to operate;

FIG. 2 is a simplified graphical representation showing macro mobility of 25 mobile node in a third generation wireless, mobile access, IP network with Mobile IP;

FIG. 3 is a simplified graphical representation showing macro mobility of mobile node and resulting Route Optimization in a third generation wireless, mobile access, IP network with Mobile IP;

FIG. 4 is a simplified graphical representation showing the steps of implementing the Kerberos key exchange method;

FIG. 5 is a flowchart showing processes of implementing IPsec according to the present invention;

FIG. 6 is a flowchart showing processes of initial authentication and ticketing according to the present invention;

FIG. 7 is a flowchart showing processes of establishing a session key according to the present invention;

FIG. 8 is a graphical representation of a security association cache used in the present invention;

FIG. 9 is a simplified graphical representation of a mobile IP network implementing a second embodiment of the present invention where a Layer 2 secret key is also used as a Layer 3 secret key;

FIG. 10 is a simplified graphical representation of a mobile IP network implementing a third embodiment of the present invention where security association managers for managing security associations for nodes are provided; and

FIG. 11 is simplified graphical representation of a mobile IP network implementing a fourth embodiment of the present invention where security associations are stored in a subscriber identification modules in cellular phones.

### DETAILED DESCRIPTION OF THE PREFERRED EMBODIMENTS

The presently preferred embodiments of the invention are described herein with reference to the drawings, wherein like components are identified with the same references. The descriptions of the preferred embodiments contained herein are intended to be exemplary in nature and are not intended to limit the scope of the invention.

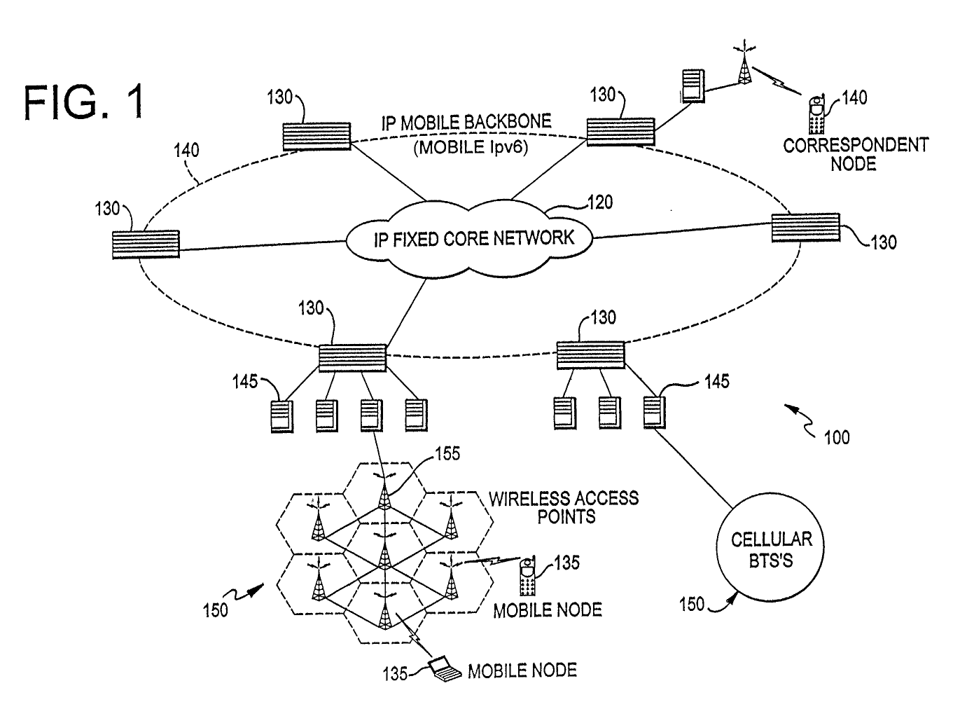

FIG. 1 illustrates graphically an exemplary third generation, wireless, mobile access, IP network 100 in which the invention is intended to find application. For purposes of the present description, it is assumed the data network 100 adheres to the IMT-2000 standards and specifications of the ITU for wireless, mobile access networks. Additionally, it is assumed the data network 100 implements Mobile IP support according to the proposed Mobile IPv6 and IPv4 standards of the IETF. These standards and specifications, as published on the web sites of ITU and IETF, have been incorporated herein by reference.

The wireless, mobile access, IP network 100 has as its core a fixed node IP data network 120 comprising numerous fixed nodes (not shown), i.e., fixed points of connection or links. Digital data is communicated within and over the network in accordance with Internet protocols such as Internet protocol version 6, specified as IETF RFC 2460, which is incorporated herein by reference. Built on the core network 120 is a collection of gate routers 130 which collectively form an IP mobile backbone 140 and function, in accordance with the conventional Internet addressing and routing protocols, to route packets of data between source and destination nodes connected to the network. The gate routers 130 forming the IP mobile backbone 140 are themselves nodes of the core network 120 and have unique IP addresses for communication over the core network 120. Connected to each of the gate routers 130 is servers or routers 145, which also have unique IP addresses and function as home agents (HA) and foreign agents (FA) to interface mobile nodes 135 and correspondent nodes 140 to the core network 120, as specified in IETF RFC 2002 (“Mobile IP Version 4”), which has been incorporated herein by reference. The mobile and correspondent nodes may be different kinds of mobile, wireless communication devices including cellular handsets, cellular telephones, hand-held computers, personal information managers, wireless data terminals, and the like.

Pursuant to RFC 2002, each of the mobile and correspondent nodes 135, 140 is assigned a home network. Each node 135, 140 also has a home agent 145, which is in fact a router on its home network. For each of the mobile and correspondent nodes 135, 140, the home agent is the point of attachment to the network 120 when the node is operating in its home network area. The mobile node's home agents 145 functions to route packets to and from the mobile node when it is operating in its home network area. According to the proposed Mobile IP support standards, the mobile node's home agent 145 also functions to maintain current location information for the mobile node 135, i.e., the mobile node's care-of address, when it is operating away from its home network area, and continues to participate in routing, or tunneling, packets to the mobile node 135 at its foreign location, at least in the proposed base Mobile IPv4 standard.

Other routers 145 function as foreign agents. Foreign agents provide network access points for the mobile node 135 when it is operating away from its home network area. The foreign agent via which a mobile node is connected to the network at a given time and location, also functions to route packets to and from the mobile node 135.

Each agent 145 has a base transceiver station network 150 by way of which the mobile nodes 135, 140 communicate with their agents 145. Each of the base transceiver station networks 150 comprises a multiple base transceiver stations (BTSs) 155. The mobile nodes 135, 140 and the BTSs employ known CDMA, W-CDMA or similar digital data communication technology to communicate with 15- each other. The construction, arrangement, and functionality of the BTS networks 150 or BTSs 155 are conventional and standard. Similarly, the implementation of CDMA, W-CDMA or similar digital data communication technology in wireless, mobile node devices 135 and BTSs 155 is standard. Detailed description thereof is not necessary to a complete understanding and appreciation of the present invention and is therefore omitted.

Each node performs sending and receiving of packets according to the open system interconnection (OSI) standard. The OSI standard defines a framework for implementing protocols for communications in seven discrete layers, i.e., Application Layer (Layer 7), Presentation Layer (Layer 6), Session Layer (Layer 5), Transport Layer (Layer 4), Network Layer (Layer 3), Data Link (MAC) Layer (Layer 2), and Physical Layer (Layer 1). According to the OSI standard, control is passed from one layer to the next, starting at the top layer (Layer 7) in the source node and proceeding down to Layer 1 therein, and over the network to the destination node where the control climbs up the layers from the bottom to the top. Among the layers, the bottom three layers are responsible for basic communication protocols. For instance, Layer 1 is responsible for passing bits onto and receiving them from a BTS. This layer has no understanding of the meaning of the bits, but deals with the electrical and mechanical characteristics of the signals and signaling methods. Layer 2 is responsible for validity and interiority of communications with a BTS. This layer has some understanding of the meaning of the bits and deals with the communication protocols with a BTS. Layer 3 is responsible for establishing communication routes in networks. This layer has full understanding of the meaning of data and deals with addressing, routing and security protocols.

Within the overall data network 100, three levels of mobile node mobility are contemplated. Macro-mobility refers to a change in location of a mobile node such that it leaves its home network and enters a network served by another agent. In other words, the mobile node's link or connection to the data network changes from one agent to another. Macro-mobility encompasses changes between a home and foreign agent or between foreign agents, and is also called inter-agent mobility. Intermediate mobility refers to a change in location of a mobile node wherein its link to the network changes from one BTS network to another. Finally, micro-mobility refers to a change in location of a mobile node within a BTS network 150, in which case the mobile node's network link does not change.

The handling of intermediate mobility and micro-mobility are well known in wireless, cellular communication networks. For example, it is well known to use beacon signal strength for detecting and handling communication hand-offs between BTSs when a mobile node device 135 changes location on a micro-mobility scale. Similarly, the detection and handling of communication hand-offs between BTS networks when a mobile node 135 changes location across BTS network boundaries is standard. In both cases, a detailed description is unnecessary to attain a complete understanding and appreciation of the present invention and is therefore omitted.

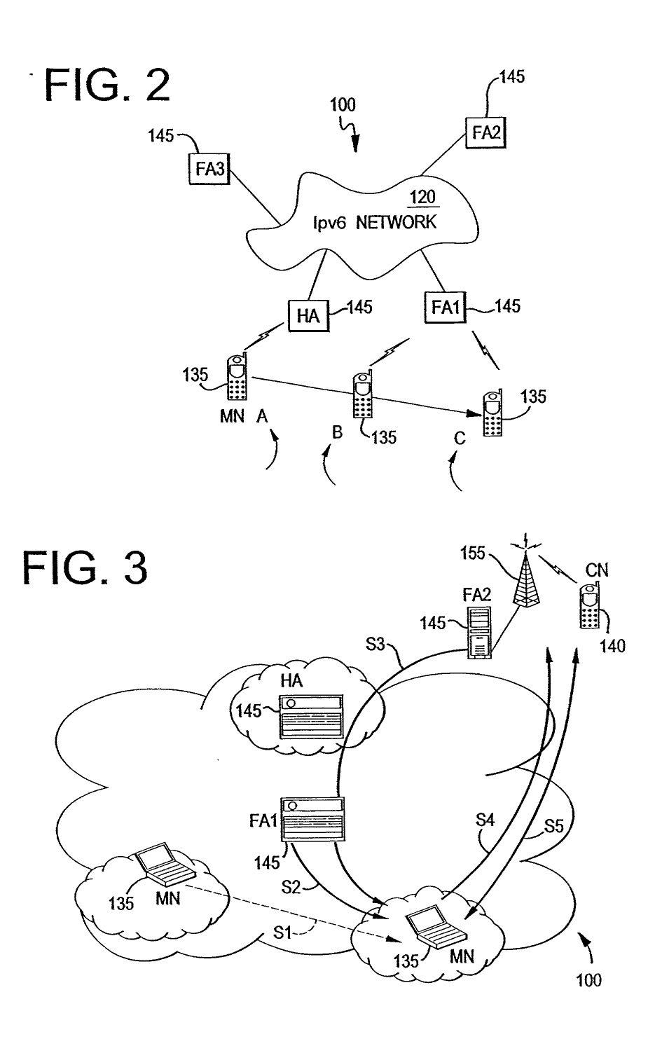

In the context of the present example, the invention is applied in connection with the macro-mobility level wherein a mobile node changes location within the network such that its network link changes from one agent to another. However, in other contexts, such as the wireless LAN context, the invention will find applicability at micro-mobility level. FIG. 2 provides a simplified graphical illustration of mobile node macro-mobility and the hand-off process in a third generation, wireless, mobile access data network embodying Mobile IPv6 mobility support. In that example, the network connection hand-off operation between agents that results from mobile node macro-mobility is specified in IETF RFC 2002 for proposed Mobile IPv 4 and in “draft-ietf-mobileip-ipv6-12.txt” at “www.ietf.org/internet-drafts” for proposed Mobile IPv6.

In FIG. 2, the network 100 includes the IPv6 network 120 and routers or agents 145 connected to the IPv6 network 120. The hand-off process begins with a mobile node (MN) 135 at a starting location A. In the example illustrated, the MN 135 at starting location A is operating within its home link and connected to the network 120 via a home agent (HA) 145. The MN 135 preferably communicates with agents 145, including its HA 145, wirelessly using CDMA, W-CDMA or similar wireless broadband spread-spectrum signal technology, for example, via BTSs, which are not shown in this example.

Both Mobile IPv6 and IPv4 standards provide mobility detection and handoff functionality. In both versions, mobility of the MN 135 is detected via a Neighbor Discovery mechanism and results in a hand-off of the mobile node's network connection from a first agent to a second agent when the mobile node travels away from the area served by the first agent and enters the area served by the second agent. Thus, while the example illustrated is described with respect to a Mobile IP version 6 network, similar functionality and considerations exist for Mobile IP version 4 networks.

As the MN 135 moves from the starting location A to intermediary location B, its movement is detected by an IP movement detection methodology or any combination of the methodologies available to it. The primary movement detection methodology for Mobile IPv6 uses the facilities of IPv6 Neighbor Discovery methodology including Router Discovery and Neighbor Unreachability Detection. The Neighbor Discovery is described in detail in IETF RFC 2461 entitled “Neighbor Discovery for IP Version 6 (IPv6), which is incorporated herein by reference, and which is recommended for Mobile IPv6 mobile nodes in the IETF Mobile IP Version 6 draft document previously identified and incorporated by reference.

While traveling from location A to location C through location B, the MN uses Router Discovery to discover new agents and on-link subnet prefixes. The Router Discovery operations include broadcasting of a Router Solicitation message by the MN. If foreign agent 145 (FA1) is situated sufficiently close to the MN to be able to receive the Router Solicitation message, it will respond directly to the MN 135 with a Router Advertisement message. Alternatively, the MN 135 may simply wait to receive an unsolicited (periodic) Router Advertisement message from the FA1. When the MN 135 receives a Router Advertisement message from FA1, the MN maintains an entry of the FA1 on its Default Router List and the FA1's subnet prefix on its Prefix List. Thus, the Default Router List identifies the FA1 as a candidate default agent with which the MN 135 may establish a new network connection.

While the MN 135 is leaving the HA 145, it is important for the MN to be able to quickly detect when the HA becomes unreachable, so that it can switch to a new agent and to a new care-of address. To detect when its default agent becomes unreachable, the MN 135 uses Neighbor Unreachability Detection. In FIG. 2, at some point as the MN 135 reaches intermediary location B and continues toward location C, its network connection via the HA 145 begins to degrade. The degrading of the communication manifests itself as weakening of the L2 beacon signal and an increase in communication error detected by the MAC layer (Layer 2). Whether it is still reachable or not from the HA 145 is determined based on: (1) the loss of TCP acknowledgements in response from the HA 145 to packets if the MN 135 is in communication with the HA 145; and/or (2) the loss of unsolicited multicast Router Advertisement messages from the HA 145; and/or (3) receipt of no Neighbor Advertisement message from the HA 145 in response to an explicit Neighbor Solicitation messages to it.

If the MN 135 detects that its communication with the HA 145 begins to degrade, it has to begin hand-off operations and finish them before it completely loses the HA 145. The MN 135 first looks up its Default Router List and finds the FA1. The MN 135 then establishes a communication link with the FA1 and closes the communication link with the HA 145. The communication hand-off between the HA 145 and FA1 requires the MN 135 to establish a new “care-of” IP address identifying its new foreign agent FA1. Preferred procedures for address auto-configuration are specified in IETF RFC 2462 entitled “IPv6 Stateless Address Autoconfiguration,” which is incorporated herein by reference. According to the procedures, the mobile node's new care-of address is formed from the FA1's subnet prefix on the Prefix List that was advertised by the FA1. After these hand-off operations, by the time the MN 135 reaches its new location C, its network link has been established through the foreign agent FA1.

FIG. 3 graphically summarizes the steps taken for the registration of the new care-of address and Route Optimization after the above hand-off operations are completed. In Step 1 (S1), the MN 135 hands-off its network communication from the HA 145 to the foreign agent (FA1) 145. The MN 135 configures itself with the care-of address formed on the FA1's subnet prefix sent from the FA1 (Step 2) and sends a binding update to the HA 145 via FA1. Upon receipt of the binding update, the HA 145 registers the care-of address in its binding cache for the MN 135, thereby creating an association of the MN's home address with its current care-of address. The association in the binding cache has a lifetime and lapses after a predetermined time has passed.

Suppose that after the MN 135 hands-off its network connection to the FA1, a correspondent node (CN) 140 becomes necessary to begin communication with the MN 135. Suppose further that the CN 140 has never communicated with the MN 135 and has no information about the MN's current location except its permanent home address. Thus, the CN 140 sends a first packet to the MN's home network (Step 3). The HA 145 intercepts the first packet from the CN 140 and looks up its binding cache for the MN's current care-of address. The HA 145 then encapsulates the first packet in another packet and tunnels it to the MN 135 at the MN's current care-of address via the FA1 145.

A proposed extension to the Mobile IP version 4 standard, specified in “draft-ietf-mobileip-optim-09.txt,” and published at “www.ietf.org/internet-drafts” can optimize packet routing by permitting establishment of a direct communication path between the MN 135 and the CN 140, thus bypassing the HA 145. The essence of this proposed extension has been integrated into the proposed Mobile IPv6 standards as discussed previously. Upon reception of the encapsulated packet tunneled from the HA 145, the MN 135 realizes that the CN 140 has no binding information associating the MN's home address with the MN's current care-of address. In Step 4, the MN 135 sends a binding update to the CN 140. When receiving the binding update, the CN 140 maintains an entry of the MN's care-of address in its binding cache in association with the MN's permanent home address. Any packets destined for the MN 135 from the CN 140 will thereafter be routed directly to the MN 135 from the CN 140 (Step 5). Route Optimization thus eliminates the packet-latency problem that would occur from triangular routing.

During the above binding process, authentication and security association are also performed between the MN 135 and the CN 140 to ensure the MN 135 is in fact legitimate and to avoid problems like eavesdropping, active replay attacks, and other types of attacks and unauthorized access to confidential data. Especially, the Route Optimization functionality could present serious security issues if the MN 135 sending a binding update was not properly authenticated at the CN 140, or a proper security association was not established between the MN 135 and the CN 140 for subsequent communications between them. The IETF Mobile IP version 6 draft document, which has been incorporated herein by reference, points out these security issues. IETF RFC 2401 entitled “Security Architecture for the Internet Protocol”, which has also been incorporated herein by reference, proposes the basic architecture of cryptographically-based IP security (IPsec) for both IPv4 and IPv6. IPsec provides a set of security services including authentication and confidentiality (encryption). According to RFC 2401, IPsec is implemented through the use of two traffic security protocols, the Authentication Header (AH) and the Encapsulating Security Payload (ESP), and through the use of cryptographic key management procedures and protocols. The AH and ESP play an important role in implementing IPsec and are described in detail in RFC 2402 entitled “IP Authentication Header” and RFC 2406 entitled “IP Encapsulating Security Payload”, both of which are incorporated herein by reference. Detailed discussions on cryptographic key management procedures and protocols are found in RFC 2408 entitled “Internet Security Association and Key Management Protocol (ISAKMP), which has already been incorporated therein by reference.

Among the security procedures and protocols proposed by RFC 2401, a security association (SA) is fundamental to implementation of IPsec. A SA is a relationship between two nodes that describes security services the nodes agree to use in order to communicate securely between them. A SA is uniquely identified by a triple consisting of a Security Parameter Index (SPI), an IP Destination Address and a security protocol (AH or ESP) identifier. The SPI is an identifier of a security protocol. The IP Destination Address indicates a home address or care-of address of the node at the other end of the communication. A node carries one SA for each of the nodes with which it is communicating or has communicated. Each SA has its own lifetime and expires after a predetermined time has passed. A SA has to be established between nodes before the nodes start exchanging packets that include data to be protected.

The establishment of a SA is important part of the key management protocol in cryptographically-based IPsec such as the one proposed by RFC 2401. The basic idea behind the cryptographically-based IPsec is that two nodes share a secret session key for use in encrypting and decrypting communications between them. Thus, the establishment of a SA necessarily includes the establishment of a shared secret session key. There are two methods for key establishment. One method is called key transport in which a trusted third party, a key distribution center (KDC), holds secret session keys for all nodes within its network domain and distributes a secret session key to nodes wanting to begin a communication between them. The other method is called key generation. An example of key generation is the use of the Diffie-Hellman (D-H) algorism to generate a secret session key. The D-H algorithm is begun by two users exchanging public information. Each user then mathematically combines the other's information along with their own secret information to compute a share secret value. This secret value can be used as a session key or as a key encryption key for encrypting a randomly generated session key.

It will be apparent to persons skilled in the art that user authentication and establishment of a SA could take a substantial period of time to perform, resulting in increased packet latency. The present invention addresses the packet latency problem introduced by user authentication and establishment of a SA. Generally, the present invention provides a method that allows the correspondent node to initiate user authentication and establishment of a SA security, rather than waiting for the mobile node to initiate such processes after receiving a first packet from the correspondent node. Moreover, the invention replaces the conventional D-H public key algorithm, which is commonly used to encrypt and decrypt data transmitted between the mobile and correspondent nodes but requires heavy computational overhead that could be a cause for significant packet latency. The invention replaces the D-H algorithm with the Kerberos key exchange method, which requires less computational overhead. Kerberos provides authentication services for otherwise unprotected networks using a private key cryptographic algorithm based on pre-shared secret keys. IETF RFC 1510 entitled “The Kerberos Network Authentication Service (V5)”, which is incorporated herein by reference, provides detailed explanations of Kerberos.

Despite its readiness for implementation and key management, the IPsec proposed by the foregoing standards is silent about Kerberos. In fact, Kerberos as such does not fit in the framework of the proposed IPsec. Kerberized Internet Negotiation of Keys (KINK), a working group chartered to create a standards track protocol to facilitate centralized key management for IPsec as defined in RFC 2401, currently works on producing a cryptographically sound protocol for IPsec, using the Kerberos architecture as defined in RFC 1510.

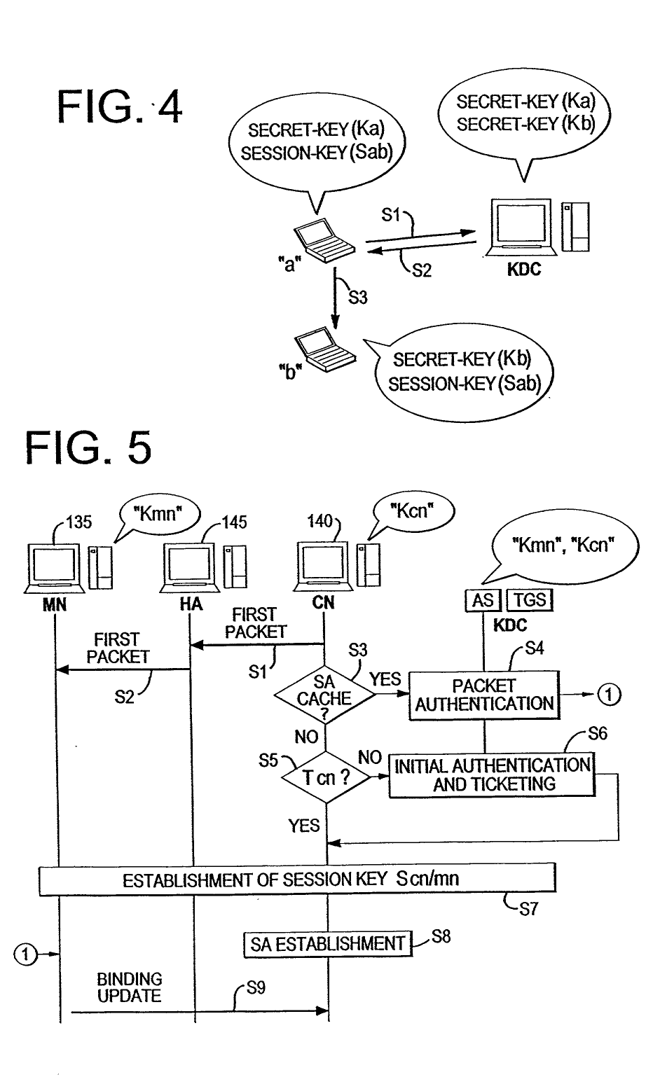

Kerberos performs authentication by using conventional cryptography, i.e., a shared secret session key distributed from a trusted third-party authentication service. FIG. 4 graphically summarizes the steps to be taken to establish the user authentication and the establishment of a SA under the Kerberos key exchange method. Nodes “a” and “b” are within the same realm covered by a key distribution center (KDC), i.e., a trusted third-party authentication service, and have pre-registered their respective secret keys Ka and Kb with the KDC. These secret keys are registered with the KDC, for instance, when the nodes a and b log in the network. Thus, the node a and the KDC share the secret key Ka, and the node b and the KDC share the secret key Kb. Those secret keys Ka and Kb are usually nearly permanent.

Now, the node a needs to communicate with the node b and requests the KDC to issue a session key for use in encrypting and decrypting communications between the nodes a and b (Step 1). In response, the KDC prepares a session key Sab and the same key Sab but encrypted by the secret key Kb. The session key Sab is prepared specifically for use in encrypting and decrypting a session of communications between the nodes a and b and thus has a short lifetime unlike the secret keys Ka and Kb. The KDC then encrypts with the secret key Ka both the session key Sab and the session key Sab encrypted by the secret key b and sends them to the node a (Step 2). Upon receipt, the node a decrypts them with its secret key Ka and extracts the session key Sab and the session key Sab encrypted with the secret key Kb (the second key). The node a cannot further decrypt the second key because it is encrypted by the secret key Kb. In Step 3, the node a sends the second key to the node b. The node b then decrypts it with its secret key Kb to extract the session key Sab, whereby the nodes a and b share the session key Sab with which subsequent communications between them will be encrypted or decrypted. The fact that the node b is able to decrypt the second key with its secret key Kb indicates that the second key must have originated from the KDC since only the KDC and the node b know the secret key Kb. The fact that each of the nodes a and b is able to decrypt subsequent communications from the other, using the session key Sab, is authentication of the identify of the sender because only the KDC and the nodes a and b know the session key Sab.

Referring to FIGS. 5-7, a preferred method of the invention will now be described in detail. FIGS. 5-7 are flow charts showing a method of implementing IPsec according to the present invention. The underlying data communication network used in these figures is the same as the one illustrated in FIG. 3, i.e., a third generation and beyond wireless, mobile-access, Internet protocol-based data network or a wireless LAN. Thus, the network used in these figures complies with the IPv4 and IPv6 standards and supports both Mobile IPv4 and IPv6. The network also complies with the IMT-2000 standards and allows mobile access by wireless using CDMA, W-CDMA or similar wireless broadband spread-spectrum signal technology. In this particular embodiment shown in the figures, the network deals with real-time interactive multimedia data communications such as VoIP. Also, the processes illustrated in these figures begin with a situation where the MN 135 has completed a hand-off from the HA 145, and the MN's care-of address is registered with the HA 145. Further more, the KDC as shown in these figures is functionally divided into two servers: an authentication server (AS); and a ticket granting server (TGS). The AS performs authentication of nodes to the TGS. The TGS performs issuance of session keys and tickets for nodes wanting to communicate with other nodes.

In FIG. 5, a correspondent node (CN) 140 needs to begin communication with the MN. Suppose that the binding cache in the CN 140 has not yet updated to reflect the MN's current care-of address. To begin a communication with the MN, the CN sends a first packet for the MN to its home network (Step 1). This first packet is a control packet, the content of which varies depending on an application needed to implement and is just a request for connection in VoIP, for example. Since the first packet usually does not contain any data to be protected, it may be sent without any IPsec protection. The first packet is intercepted by the HA and then tunneled from the HA to the MN (Step 2). Depending upon an application being implemented in the CN, however, the first packet may not be a control packet but a packet that contains data to be protected by IPsec before sent to the MN. If so, the Steps 1 and 2 will be skipped directly to Step 3 to establish a security association (SA) between the CN and the MN.

The constituents of the network illustrated in FIGS. 5 all agree to use Kerbros as the primary vehicle for implementing IPsec. Accordingly, the network has a key distribution center (KDC) for managing all of the encryption keys used within the network. As discussed above, the KDC consists of an authentication server (AS) and a Ticket Granting Server (TGS). Also, the MN and the KDC share a secret key Kmn that was established when the MN logged in the network. The CN and the KDC share a secret key Kcn that was likewise established at the login session by the CN. Please note that there is a type of network access devices for which secret keys are created and shared with the KDCs upon purchase of the devices.

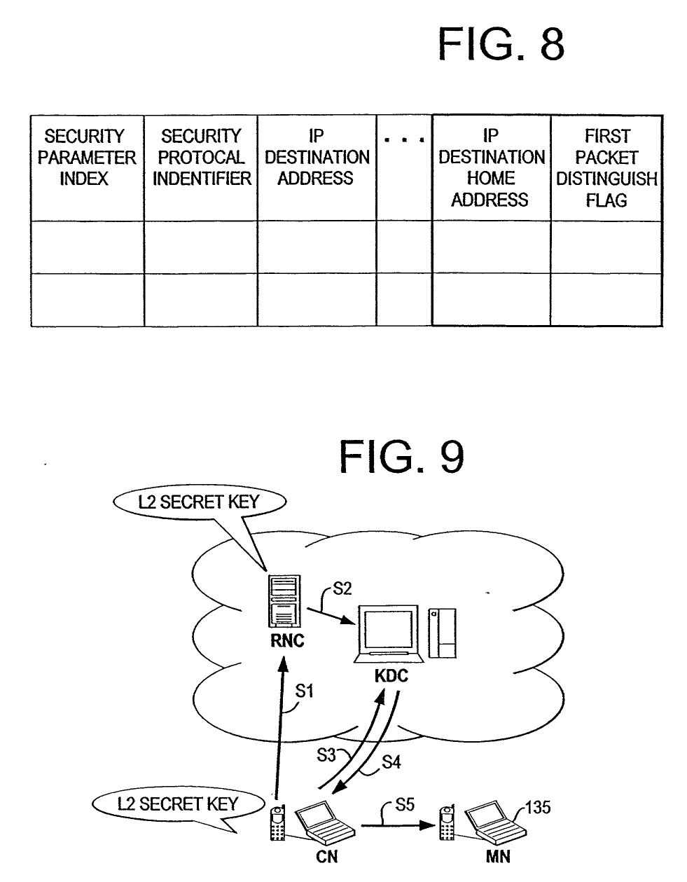

After sending out the first packet, the CN looks up its security association (SA) cache to see if there is any SA established for communication with the MN (Step 3). FIG. 8 shows a SA cache used in this embodiment. As shown in FIG. 8, the SA cache may have multiple SA entries. One SA entry corresponds to one node with which the CN is currently communicating or has communicated in the past. A SA is identified by several parameters including a Security Parameter Index, a Security Protocol Identifier and an IP destination address. These three parameters have already been discussed and therefore will not be explained here to avoid redundancy. In addition to these three parameters, a SA in this embodiment has two parameters. One of the two parameters is called an “IP destination home address,” and the other is called a “first packet flag.” The IP destination home address stores the home address of the node at the other end of the communication. The first packet flag is turned on when a first packet is sent to a node with which no SA is established and turned off when a SA is established with the node. A SA has a lifetime and expires after a certain time has passed. When the lifetime expires, the SA entry is erased from the SA cache.

Returning to Step 3 in FIG. 5, the CN looks up its SA cache to see if there is any SA entry for the MN. If a SA entry for the MN is found in the SA cache, the CN moves to Step 4 in which it encrypts any subsequent packets with the Kerberos session key identified by the Security Parameter Index in the SA entry and send them to the MN. If there is no SA entry for the MN, the CN moves to Step 5. If the CN has never communicated with the MN, there is no SA entry for the MN. Also, if the CN has communicated with the MN before, yet it was sufficiently long time ago, the SA entry for the MN has expired and has been erased from the SA cache. If no SA entry for the MN is found, a new SA has to be established to protect subsequent communications with the MN. According to the conventional IPsec protocol, in similar situations, SA establishment is begun when the CN receives a binding update from the MN. More specifically, according to the conventional IPsec protocol, upon receipt of the first packet from the CN that has been tunneled by the HA, the MN realizes that the CN does not know the current location of the MN and sends a binding update to the CN to have the CN update its binding cache. A SA is established after the CN receives a binding update from the MN. In other words, in the conventional IPsec protocol, the MN initiates SA establishment by sending a binding update to the CN. However, since no substantive communication can be exchanged between the CN and the MN until a SA is established between them, it will be apparent to persons skilled in the art that the conventional IPsec protocol under which a SA establishment is not begun until a binding update reaches the CN causes significant packet latency.

The present invention allows the CN to initiate SA establishment, rather than making the CN wait for the MN to initiate SA establishment after receiving a first packet from the CN. In Step 5, the CN reserves one SA entry for the MN in its SA cache as shown in FIG. 8 and turns on the first packet flag in the SA entry. The fact that the first packet flag is turned on indicates that SA establishment is in progress. Although a packet that contains data to be protected cannot be sent until a SA is established, a control packet can be sent without protection. The CN is allowed to send any subsequent control packets to the MN but is prohibited by the first packet flag from repeatedly initiating SA establishment with the MN. The CN then determines whether it is authorized to communicate with the KDC. More specifically, the CN determines whether it has a Kerberos ticket for authenticating itself to the KDC. If it does not have such a ticket, it moves to an initial authentication step (Step 6) to obtain the ticket from the KDC. If it already has the ticket, it moves to Step 7 to request to the KDC an authentication service so that it can communicate with the MN.

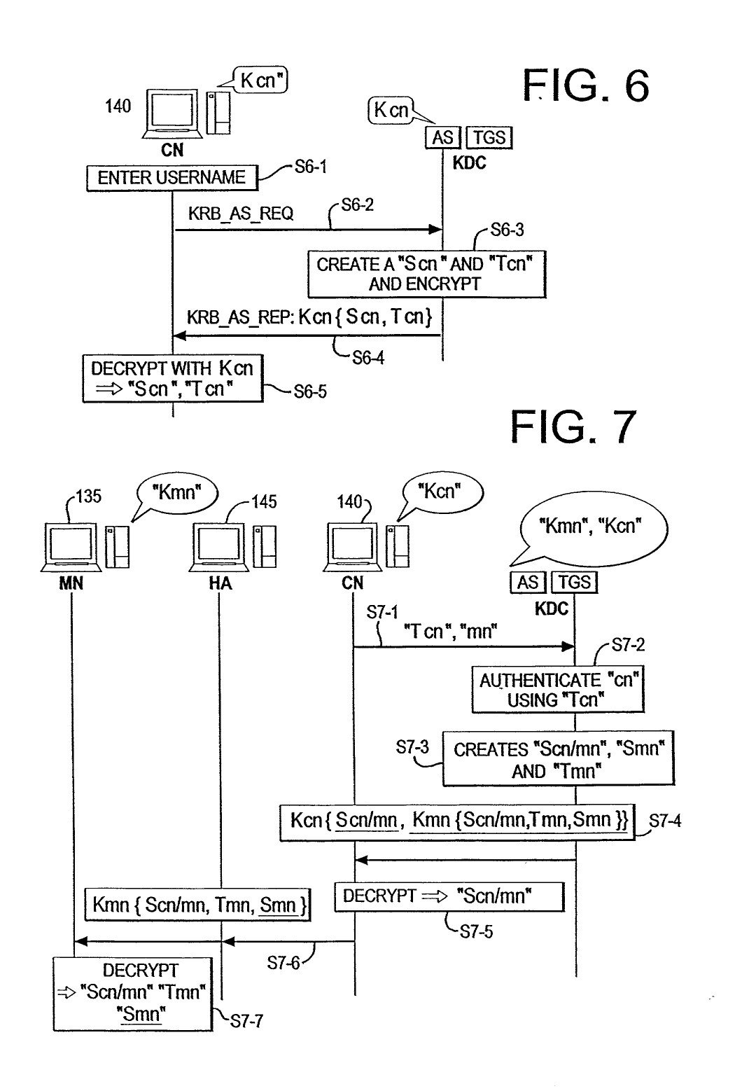

The details of Step 6 are shown in FIG. 6. In the initial authentication step (Step 6), the user is first required to enter her username (Step 6-1). Then, the CN sends a Kerberos authentication request (KRB_AS_REQ), along with the username, to the AS (Step 6-2). After confirming the username and retrieving the secret key Kcn, the AS creates a session key Scn and a ticket Tcn in Step 6-3. The AS encrypts both the session key Scn and the ticket Tcn, using the secret key Kcn, and sends them to the CN in a Kerberos authentication reply (KRB_AS_REP) (Step 6-4). Please note that Kcn{Scn, Tcn} means both session key Scn and ticket Tcn are encrypted with the secret key Kcn. Upon receipt of the KRB_AS_REP, the CN decrypts it with its secret key Kcn and extracts the session key Scn and the ticket Tcn (Step 6-5). The CN now has the ticket Tcn for authenticating itself to the TGS and moves to Step 7, the details of which are shown in FIG. 7.

In FIG. 7, the CN sends the TGS, along with the ticket Tcn, a request requesting the TGS to issue a session key for communications with the MN (Step 7-1). The ticket Tcn functions as a credential for authenticating the CN to the TGS. After authenticating the request with the ticket Tcn (Step 7-2), the KDC creates, in Step 7-3, a session key Scn/mn, a session key Smn and a ticket Tmn. The session key Smn is to be used to protect communications between the MN and the KDC. The ticket Tmn is to be used as a credential for authenticating the MN to the KDC. If the MN has communicated with the KDC and already established the session key Smn and ticket mn with the KDC, the TGS does not issue these key and ticket. First, the session key Smn, session key Smn and ticket Tmn are encrypted, using the secret key Kmn, i.e., Kmn{Scn/mn, Tmn, Smn}. The TGS then encrypts both session key Scn/mn and Kmn{Scn/mn, Tmn, Smn}, using the secret key Kcn, i.e., Kcn{Scn/mn, Kmn{Scn/mn, Tmn, Smn}} and sends them to the CN (Step 7-4). In Step 7-5, the CN decrypts them with the secret key Kcn and extracts the session key Scn/mn and Kmn{Scn/mn, Tmn, Smn}. Since Kmn{Scn/mn, Tmn, Smn} is encrypted with the secret key Kmn, the CN cannot further decrypt it. The CN sends out Kmn{Scn/mn, Tmn, Smn}, which is intercepted by the HA and then tunneled by HA to the MN (Step 7-6). Upon receipt, the MN decrypts Kmn{Scn/mn, Tmn, Smn} with its secret key Kmn to extract the session key Scn/mn, Tmn and Smn (Step 7-7).

Returning to FIG. 5, after completing Step 7, the CN maintains an entry in its SA cache for the SA just established for communications with the MN (Step 8). Specifically, in the SA cache as shown in FIG. 8, the CN fills the SA entry for the MN with necessary information including the security parameter index identifying the session key Scn/mn. The CN also turns off the first packet flag in the same entry. The corresponding SA entry is also made in the SA cache in the MN. The CN and the MN thus share the same session key Scn/mn and can communicate securely thereafter. Lastly, the MN sends a binding update to the CN in response to the first packet sent from the CN (Step 9). Since the present invention allows the CN to initiate SA establishment, packet latency associated with SA establishment will be significantly reduced.

FIG. 9 shows another embodiment of the present invention. A secret key established for Layer 2 authentication between a mobile node and a radio network controller (RNC) may be used for Layer 3 authentication if the above CN is a mobile node. A RCN implements Layer 2 communication protocols such as call and connection control, radio interface support and mobility management. When a mobile node is trying to establish wireless connection with a network for the first time, a Layer 2 secret key is established for authentication of the mobile node to the RNC. On the other hand, the above secret keys Kmn and Kcn established between the KDC, and the CN and the MN are secret keys used for Layer 3 authentication. In other words, when establishing wireless connection with the network, a mobile node has to have a secret key for Layer 2 authentication. After the connection is established, the mobile node again has to have another secret key for Layer 3 authentication to authenticate itself to the KDC in the network. It will be apparent to persons skilled in the art that although their purposes are different, establishing two separate secret keys may be considered redundant operations. Thus, to eliminate the redundancy, in the present invention, a Layer 2 secret key is also used as a Layer 3 secret key.

FIG. 9 shows a wireless data communication network in which one secret key is used for both Layer 2 and Layer 3 authentication. In FIG. 9, the CN is a mobile node and establishes a Layer 2 secret key between itself and the RNC when it establishes wireless connection (Step 1). The Layer 2 secret key is sent from the RNC to the KDC in the network (Step 2). Within the CN, the Layer 2 secret key is reported to its Layer 3. The CN and KDC thus share the same secret key. There is no need to establish a Layer 3 secret key between the CN and the KDC to authenticate the CN to the KDC. When it becomes necessary for the CN to communicate with the MN, the CN initiates SA establishment as described above and requests the KDC to issue a session key for a communication between the CN and the MN (Step 3). When requesting a session key, the CN authenticates itself to the KDC, using its Layer 2 secret key shared with the KDC. The KDC sends the CN a session key and the same session key encrypted by MN's Layer 2 secret key, both of which are then encrypted by CN's Layer 2 secret key (Step 4). The CN decrypts them with its Layer 2 secret key to extract the session key. It then sends the session key further encrypted by MN's Layer 2 secret key to the MN (Step 5), which will decrypt the session key with its secret key.

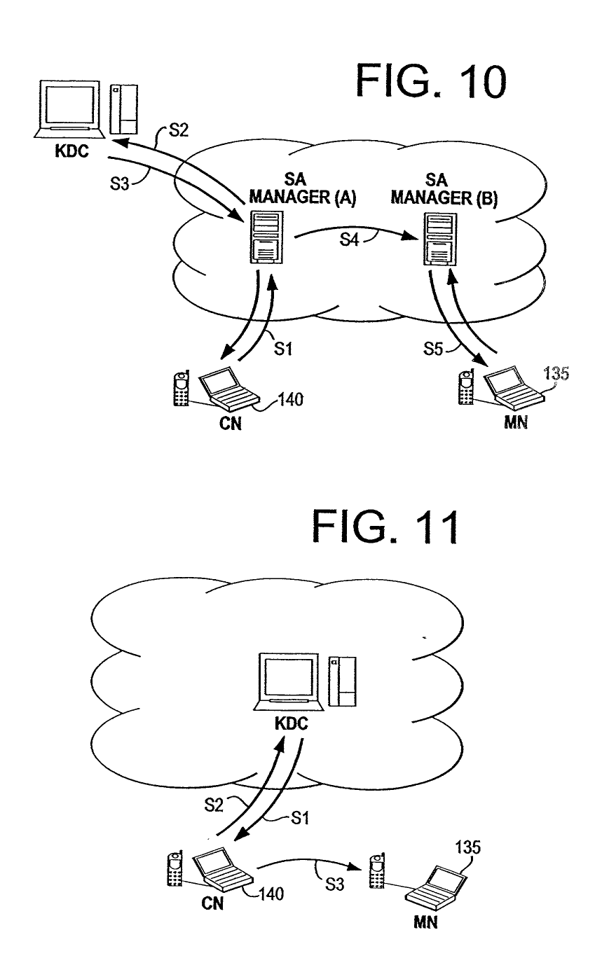

FIG. 10 shows another embodiment of the present invention. A session key is issued to protect a session of communications and has a lifetime. Therefore, to begin a new session of communications, a new session key has to be obtained from the KDC. Also, if a session of commutations takes long to complete due to an unexpected communication problem, the session key may expire in the middle of the session. If a session key expires in the middle of a session, the communication session has to be stopped and cannot be resumed until a new session key is obtained from the KDC. In the network shown in FIG. 10, session keys have long lifetimes and are reusable over multiple sessions of communications until they expire. However, if session keys have long lifetimes, a node may have to curry a large number of SA entries. Usually, mobile nodes do not have a sufficient memory space to carry a large number of SA entries. To cope with this problem, the network shown in FIG. 10 has SA managers for managing SAs on behalf of mobile nodes connected to the network.

In FIG. 10, when it becomes necessary for the CN to communicate with the MN, the CN initiates SA establishment as described above and requests a session key to its SA manager (A) (Step 1). In response, the SA manager (A) looks up its SA entries for any SA established to protect communications between the CN and the MN. Since SAs have long lifetimes, if the CN and MN have communicated before, there may still remain a SA established for the previous communication between the CN and the MN. If the SA manager (A) still keeps the SA from the previous communication, it sends the session key identified by the SA to the CN. The CN then sends the MN packets encrypted with the session key from the previous communication with the MN. When receiving the packets from the CN, the MN requests its SA manager (B) for the session key for decrypting the packets from the CN. The lifetime of the session key from the previous communication has to be the same both on the SA managers (A) and (B). Therefore, the same session must be still valid on the SA manager (B). In response to the request, the SA manager sends the session key to the MN. The MN then decrypts the packets from the CN, using the session key from the SA manager (B).

If the SA manager (A) does not have a SA for communication between the CN and the MN, the SA manager (A) then requests the KDC to issue a new session key (Step 2). In reply, the KDC returns a session key to the SA manager (A) (Step 3). The SA manager establishes a SA inside thereof for communication with the MN and then distributes the session key to the CN and the SA manager (B) (Step 4). The SA manager (B) then establishes the corresponding SA and sends the session key to the MN (Step 5). During the distribution between the KDC and the CN and between the CN and the MN, the session key is protected by CN's secret key and MN's secret key as discussed above. Since SAs and thus session keys have long lifetimes, it becomes less frequent to request the KDC to issue session keys. Therefore, packet latency resulting form the KDC issuing session keys is reduced. Also, communication costs are calculated based on the number of packets transmitted. Since it becomes less frequent to request the KDC to issue session keys, the number of packet necessary to establish SAs is reduced, thereby reducing communication costs.

FIG. 11 shows wireless data communication network that implements another embodiment of the present invention. Like the embodiment as shown in FIG. 10, SAs and thus session keys have long lifetimes. However, in the embodiment shown in FIG. 11, SAs are stored in the subscriber identification modules (SIMs) in mobile phones. A SIM is smart card that has a microchip embedded therein. The chip contains the subscriber's account details along with information on service access and preferences. The IPsec protocols implemented in this embodiment are similar to those in the embodiment shown in FIG. 10. That is, when it becomes necessary for the CN to communicate with the MN, the CN looks up the SA entries in the SIM in its mobile phone Pcn for any SA established to protect communication between the CN and the MN. If the SIM in the mobile phone Pcn still keeps the SA from the previous communication, it notifies the CN of the session key identified by the SA. The CN sends the MN packet encrypted with the session key from the previous communication. When receiving the encrypted packets from the CN, the MN requests obtains the session key stored in the SIM in its mobile phone Pmn and decrypts the packets from the CM, using the session key obtained from the SIM in the mobile phone Pmn.

If no SA for communication between the CN and the MN is stored in the SIM in the mobile phone Pcn, the CN requests the KDC to issue a new session key (Step 1). In reply, the KDC returns a session key to the CN (Step 2). The CN establishes a SA for the MN and stores it in the SIM in the mobile phone Pcn. The CN then sends the session key to the MN (Step 3). The MN then creates the corresponding SA and stores it in the SIM in the mobile phone Pmn. As discussed above, during the distribution between the KDC and the CN and between the CN and the MN, the session key is protected by CN's secret key and MN's secret key.

Like the embodiment shown in FIG. 10, in this embodiment, since SAs and thus session keys have long lifetimes, it becomes less frequent to request the KDC to issue session keys. Therefore, packet latency resulting form the KDC issuing session keys is reduced. Since it becomes less frequent to request the KDC to issue session keys, the number of packet necessary to establish SAs is reduced, thereby reducing communication costs. In addition, since this embodiment does not have any intermediate servers such as the SA managers as shown in FIG. 10 intercepting communications, security is increased.

What have been described are preferred embodiments of the present invention. The foregoing description is intended to be exemplary and not limiting in nature. Persons skilled in the art will appreciate that various modifications and additions may be made while retaining the novel and advantageous characteristics of the invention and without departing from its spirit. Accordingly, the scope of the invention is defined solely by the appended claims as properly interpreted.

What is claimed is:

1. A method of implementing Internet protocol security in a mobile IP network, comprising the steps of:
initiating communication from a first node to a second node;
checking by the first node if any security association is established with the second node; and
initiating by the first node establishment of a security association for protecting communications with the second node if no security association is established with the second node.

2. A method as recited in claim 1, wherein the second node is a mobile node situated away from its home link.

3. A method as recited in claim 2, wherein the first node initiates communication with the second node by sending a control packet to the second node through the second node's home agent and the second node in response returns a binding update to the first node.

4. A method as recited in claim 1, wherein the security association established employs a Kerberos key exchange method.

5. A method as recited in claim 4, wherein at least one of the first and second nodes uses a secret key established in Layer 2 for Layer 3 authentication.

6. A method as recited in claim 1, wherein the network has security association managers, and the security association is established by the security association managers.

7. A method as recited in claim 1, wherein the first and second nodes have a subscriber identification module, and the security association established is stored in the subscriber identification module.

8. A method as recited in claim 1, wherein the security association has a long lifetime and is used over multiple sessions of communications between the first and second nodes.

9. A method as recited in claim 1, wherein the communication is a real-time interactive digital data communication.

10. A method as recited in claim 9, wherein the real-time interactive digital data communication is voice over Internet protocol.

11. A method as recited in claim 1, wherein the network complies with International Mobile Telecommunications-2000 standards.

12. A method for implementing Kerberos-based Internet security protocol in a mobile IP network, comprising the steps of:
establishing a Layer 2 secret key between a node and a base transceiver station when the node is establishing wireless connection with the base transceiver station;
reporting the established Layer 2 secret key from a Layer 2 to a Layer 3 in the node; and
using the reported Layer 2 secret key to authenticate the node to the network when the node logs in the network.

13. A method as recited in claim 12, wherein the communication is a real-time interactive digital data communication.

14. A method as recited in claim 13, wherein the real-time interactive digital data communication is voice over Internet protocol.

15. A method as recited in claim 12, wherein the network complies with International Mobile Telecommunications-2000 standards.

16. An IP network comprising:
nodes communicate with each other over the network;
security association mangers provided in the network for managing security associations for the nodes, wherein when asked by a first node that needs to communicate with a second node, a security association manager returns to the first node a security association previously established for communication with the second node if the security association remains stored inside thereof, and if there is no security association stored for communication with the second node, the security association manager conducts establishment of a security association, stores the security association inside thereof and distributes it to the first node.

17. An IP network as recited in claim 16, wherein the network adopts a Kerberos key exchange method and has a key distribution center for distributing session keys to the security association managers for nodes that need to make communications.

18. An IP network as recited in claim 17, wherein the security association manager requests the key distribution center to issue a session key.

19. A method as recited in claim 16, wherein the communication is a real-time interactive digital data communication.

20. A method as recited in claim 19, wherein the real-time interactive digital data communication is voice over Internet protocol.

21. A method as recited in claim 16, wherein the network complies with International Mobile Telecommunications-2000 standards.
